(19) United States
(12) Patent Application Publication
(10) Pub. No.: US 2013/0064482 A1
(43) Pub. Date: Mar. 14, 2013

(54) DAMPING SYSTEM FOR FITTINGS

(71) Applicant: Pater Jaehrling, Buende (DE)

(72) Inventor: Pater Jaehrling, Buende (DE)

(21) Appl. No.: 13/642,635

(22) PCT Filed: Apr. 14, 2011
(86) PCT No.: PCT/EP11/55885

§ 371 Date: Nov. 19, 2012

(30) Foreign Application Priority Data
Apr. 22, 2010 (DE) 10 2010 016 592.1

(51) Int. Cl. E05F 5/00; F16C 29/00; E05D 11/00; F16F 7/00

(52) U.S. Cl. CPC E05F 5/00; F16F 7/00; F16C 29/005; E05D 11/00
USPC 384/7; 267/136; 16/221

(57) ABSTRACT

A damping system for fittings, in particular for domestic appliances and furniture, comprises a first fitting part (2) which can be moved relative to a second fitting part (3), wherein a damping element (4, 4′) with a housing (5) and a piston (7, 14), which is mounted such that it can move in the housing (5), is provided in order to brake the relative movement of the first fitting part (2) to the second fitting part (3) before an end position is reached, wherein a knitted fabric (6) comprising threads is arranged in the housing (5), it being possible for said knitted fabric to be compressed by the piston (7, 14) for the purpose of damping the movement of the fitting parts (2, 3).

The present invention relates to a damping system for fittings, in particular for domestic appliances and furniture, comprising a first fitting part which can be moved relative to a second fitting part, wherein a damping element having a housing and a piston that is movably supported within said housing is provided in order to slow down the relative movement of the first fitting part to the second fitting part before an end position is reached.

There are damping systems for fittings, in particular pull-out guide rails, in which the movement of a running rail is slowed down before reaching a closed position. Usually, hydraulic or pneumatic dampers are employed that are activated by movement of the fitting parts in relation to each other. However, such hydraulic or pneumatic dampers are not suitable for higher temperature ranges. In particular, employment in a baking oven is difficult, because the damping oils or the necessary elastomers seals that are used can only be employed up to a certain temperature range. Therefore especially in the case of high temperature ranges no dampers are used, which results in loud impact noises and also increases the wear and tear.

It is therefore the object of the present invention to provide a damping system for fittings that can be used even at high temperatures.

This object is achieved by a damping system having the features of claim 1.

According to the invention, a knitted fabric made of threads is arranged within the housing of the damping element, said knitted fabric being capable of being compressed by the piston in order to achieve a damping of the movement of the fitting parts. By damping the movement of the fitting parts, loud impact noises can thereby be avoided, and in addition the wear and tear on the fitting parts is reduced. The knitted fabric is compressed and can thereby slow down the relative movement between the fitting parts before an end position is reached. The material properties of the threads for the fabric can thereby be freely chosen, so that high-temperature resistant materials can be employed.

According to a preferred embodiment of the invention, the fabric is formed from metallic threads. For example, the knitted fabric can be composed of, preferably stainless, steel wool that is also stable at high temperatures. The temperature resistance of the knitted fabric is preferably above 200° C., in particular above 500° C., so that the damping system can also be used in baking ovens equipped with a pyrolytic cleaning system.

Preferably, the first and the second fitting parts are formed as the rails of a pull-out guide. The housing of the damping element can thereby be fixed to a first rail of the pull-out guide and the piston can be coupled via a driver with a second rail. In this way, the piston can be guided linearly and the driver is movably supported on a curve track so that the driver is coupled with the rail at least for a short distance before reaching the end position. The curve track can thereby have an angled end section at which the driver is pivoted in order to decouple the rail from the driver.

For a particularly compact design, the piston can also be formed integrally with a rail of the pull-out guide. The piston can, for example, be a component of a middle rail, said middle rail being arranged between a running rail and a guide rail. Then an end face of the middle rail can be used to compress the knitted fabric. The housing can then be formed also by means of the running rail and/or the guide rail. In this manner, the damping element between the rails can be arranged so as not to be visible from the outside when in the end position.

Instead of a pull-out guide, also other fittings can be equipped with a damping system according to the invention. The first fitting part and the second fitting part can, for example, be formed as pivotable hinge components, but usage in sliding doors or other fittings is also possible.

By using a knitted fabric, no leaks can occur with this damping element.

The invention will subsequently be described in more detail on the basis of two embodiments with reference to the enclosed drawings, wherein:

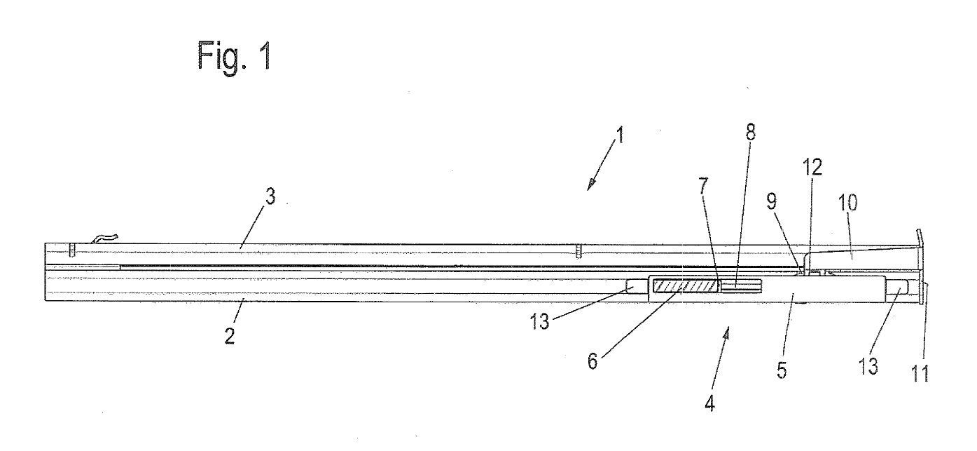

FIG. 1 shows a lateral view of a pull-out guide with a damping system according to the invention;

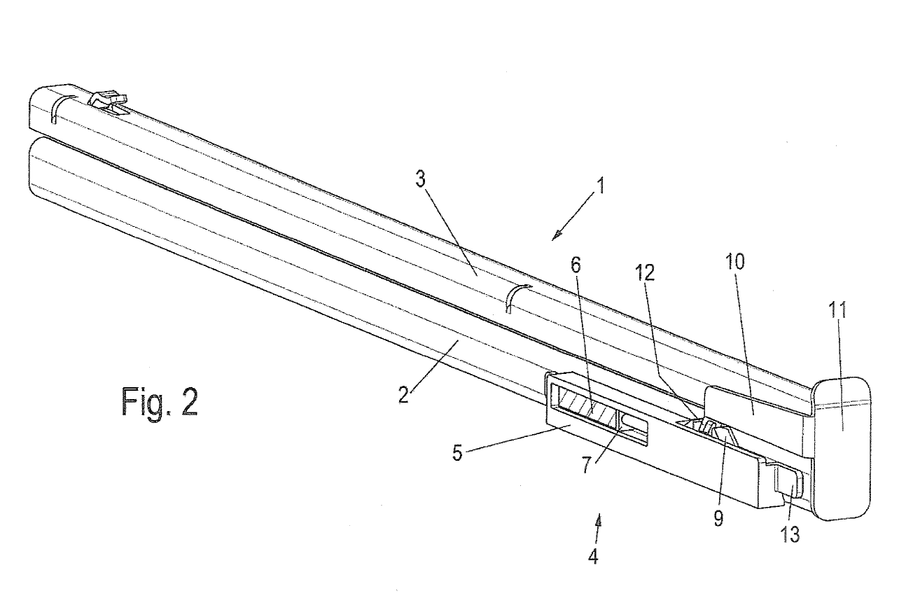

FIG. 2 shows a perspective view of the pull-out guide of FIG. 1;

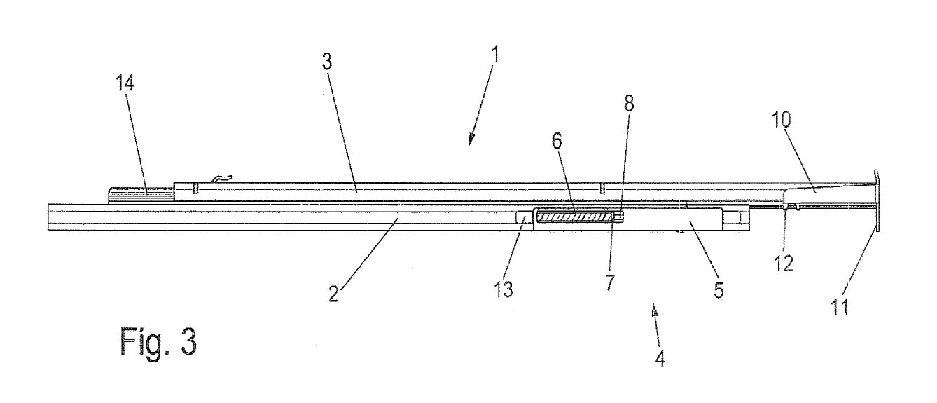

FIG. 3 shows a lateral view of the pull-out guide of FIG. 1 in an intermediate position;

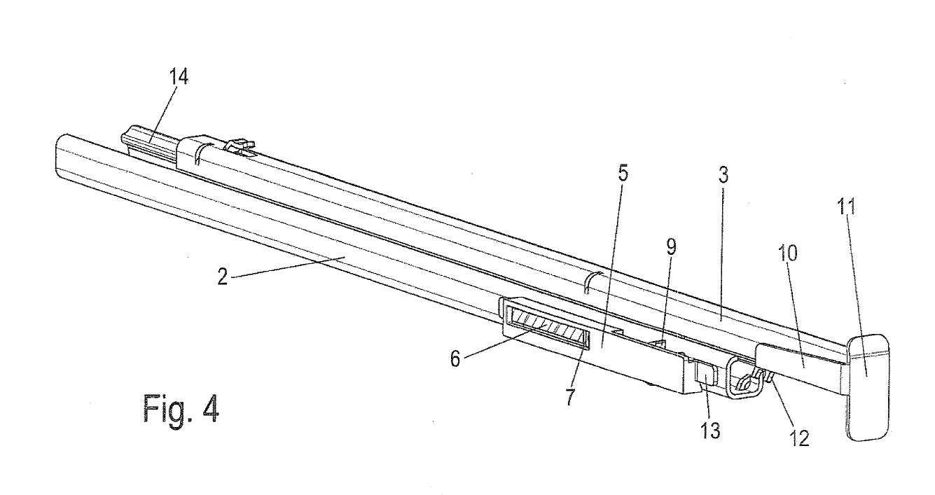

FIG. 4 shows a perspective view of the pull-out guide of FIG. 3;

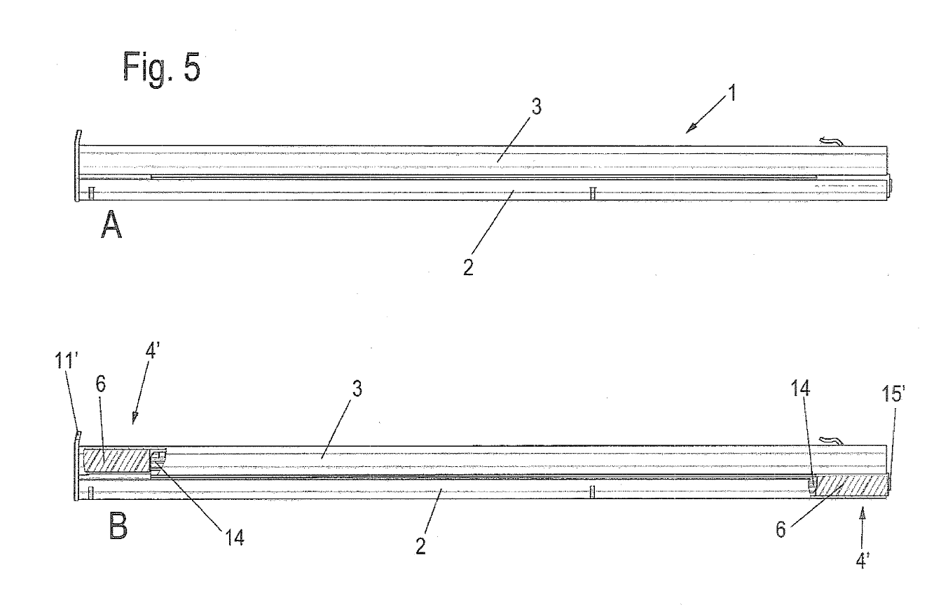

FIGS. 5A and 5B show two views of a modified embodiment of a pull-out guide with a damping system, and

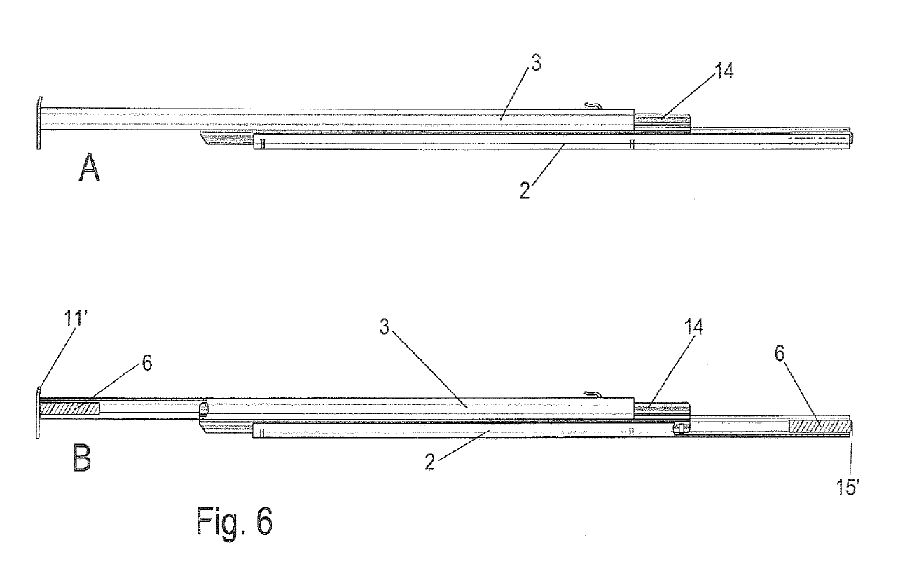

FIGS. 6A and 6B show two views of the pull-out guide of FIG. 5 with displaced running rail.

A pull-out guide 1 comprises a guide rail 2 that can be fixed, for example, to a side wall of a domestic appliance such as a baking oven, or to a body of furniture. On the guide rail 2, a middle rail 14 is movably supported by means of rolling elements. Furthermore, on the middle rail 14 there is a running rail 3 movably supported by means of rolling elements. Pull-out guides can also consist of only two, or also of more than two, rails. In order to slow down movement of the running rail 3 relative to the middle rail 14 and the guide rail 2 before reaching an end position, a damping element 4 is provided.

The damping element 4 comprises a housing 5 that is attached to the guide rail 2 by means of two lateral lugs 13. Arranged within the housing 5, is a knitted fabric 6 made of metallic threads in the form of steel wool, said knitted fabric 6 being capable of being compressed by means of a slidably supported piston plate 7. The piston plate 7 is connected to a piston rod 8 that is coupled to a driver 9. The driver 9 is movably supported along a curve track at the housing 5 and can be moved from an end position (FIGS. 1 and 2) into a slightly opened position of the running rail 3. At the end of the curve track, an angled end section is provided so that the driver 9 can be pivoted along the curve track and thereby release webs 12 of an activator 10. The activator 10 is attached at an end face of the running rail 3 by means of a plate 11. The running rail 3 can then be moved further in the opening direction and is decoupled from the driver 9 (FIGS. 3 and 4). Preferably, the driver 9 is spring loaded in the closing direction to bring about the closing movement of the running rail 3. Thus, a self-closing device is provided with the damping element according to the invention. Furthermore, in the closing direction, the spring induces a guard locking in the closed state of the pull-out guide 1. The spring induces the knitted fabric 6 for damping to remain in the compressed state until the pull-out guide 1 is moved in the opening direction.

The knitted fabric 6 of the damping element 4 consists of steel wool having a temperature resistance of over 500° C., thus enabling the damping element 4 to be used also for baking ovens equipped with a pyrolytic cleaning system. The housing 5, the piston rod 8, as well as the piston plate 7 can likewise be made of sheet steel. The knitted fabric 6 cushions a closing movement of the running rail that could otherwise lead to loud impact noises in the end position. Here, during the closing movement, the driver 9 is moved by means of the activator 10 in the closing direction and the piston plate 7 compresses the knitted fabric 6. During a movement in the opening direction, the knitted fabric 6 is decompressed again.

To reduce the tendency of the steel wool towards oxidation, said steel wool can be manufactured from stainless steel, nitrided or coated. For the coating, anorganic-organic hybrid polymers, for example, are suitable.

The knitted fabric 6 can be processed in much the same way as a non-woven fabric and have an amorphous arrangement. Alternatively, the knitted fabric can have an ordered structure in much the same way as a woven material or knitted textile. A combination is also conceivable, for example a mantle having an ordered structure and a filling with an amorphous arrangement. The mantle can, for example, be constructed like a bellows in order to assist a defined movement in the damping direction. Furthermore, in a defined construction of the damping element, the margin of fluctuation of the damping effect is reduced.

In FIGS. 1 to 4, the housing 5 is shown with an aperture so that the knitted fabric 6 is visible. As a matter of course, the housing 5 is formed in a closed fashion and surrounds the knitted fabric 6 so that said knitted fabric 6 cannot escape through an opening.

FIGS. 5 and 6 show a modified embodiment of a pull-out guide 1 having a guide rail 2 and a running rail 3. A middle rail 14 is arranged between the guide rail 2 and the running rail 3, said middle rail 14 compressing a knitted fabric 6 of a modified damping element 4′ when in the closing position. As can be seen in the sectional view of FIG. 5B, on the left hand side, a knitted fabric 6 is acted upon by an end face of the middle rail 14, wherein the knitted fabric 6 of the damping element 4′ is incorporated in a hollow space of the guide rail 2. The running rail 3 is closed off at an end face by a plate 11′ so that the knitted fabric 6 cannot be pushed out.

Moreover, a further damping element 4′ is provided at the guide rail 2, said damping element 4′ having a knitted fabric 6 comprised of threads and being capable of being compressed by an end face of the middle rail 14, said knitted fabric 6 being arranged in a hollow space of the running rail 2 that is closed by a cover 15′at an end face.

If the running rail 3 is moved out of the closing position relative to the guide rail 2 (FIGS. 6A and 6B), the knitted fabric 6 comprised of threads can slacken and unfold within the hollow space formed, respectively, by the running rail 3 or the guide rail 2. The middle rail 14 passes out of engagement with the knitted fabric 6 so that the running rail 3 can be moved freely in the opening direction and closing direction until, shortly before reaching the end position, the middle rail 14 at opposite sides comes into contact with a knitted fabric 6, thereby slowing down the closing movement.

In the displayed embodiments, the damping system is used in a pull-out guide 1. It is also possible to use the damping system for doors for baking ovens, refrigerators and also for sliding doors.

The knitted fabric 6 can be connected to the housing 5 or to a rail of the pull-out guide 1, for example by means of one or more spot welds. A mechanical fixing of the knitted fabric 6 is also possible, for example by clamping. The threads of the knitted fabric 6 can thereby also be formed as fibers having a shorter length, for example between 1 cm and 5 cm. Also, instead of metal, the material of the threads or respectively the fibers can comprise ceramic or carbon, or consist of other heat-resistant materials.

The housing 5 can furthermore surround the knitted fabric 5 in the form of a tubular sleeve.

### DRAWING REFERENCES

1 Pull-out Guide

2 Guide Rail

3 Running Rail

4 Damper Element

4′ Damper Element

5 Housing

6 Knitted Fabric

7 Piston Plate

8 Piston Rod

9 Driver

10 Activator

11 Plate

11′ Plate

12 Web

13 Lugs

14 Middle Rail

15′ Cover

1. Damping system for fittings, in particular for domestic appliances and furniture, comprising a first fitting part (2) that can be moved relative to a second fitting part (3), wherein a damping element (4, 4′) IS provided in order to slow down the relative movement of the first fitting part (2) to the second fitting part (3) before an end position is reached, characterized in that a knitted fabric (6) is arranged that is capable of being compressed for the purpose of damping the movement of the fitting parts (2, 3).

2. Damping system according to claim 1, characterized in that the knitted fabric (6) is formed from metallic threads.

3. Damping system according to claim 1, characterized in that the knitted fabric (6) has a temperature resistance of over 200° C., in particular over 500°.

4. Damping system according to claim 1, characterized in that the knitted fabric (6) is accommodated in a housing.

5. Damping system according to claim 1, characterized in that a movably supported piston (7, 14) acts on the knitted fabric (6) within the housing (5).

6. Damping system according to claim 1, characterized in that the first fitting part and the second fitting part (2, 3) are formed as rails of a pull-out guide (1).

7. Damping system according to claim 1, characterized in that the housing (5) is fixed to a first rail (2) of the pull-out guide (1) and the piston (7) can be coupled via a driver (9) with the second rail (3).

8. Damping system according to claim 7, characterized in that the piston (7) is linearly guided and the driver (9) is movably supported at a curve track.

9. Damping system according to claim 1, characterized in that the piston (14) is formed integral with a rail of the pull-out guide (1).

10. Damping system according to claim 1, characterized in that the damping element (4′) arranged between the rails (2, 3) is not visible from the outside when in the end position.

11. Damping system according to claim 1, characterized in that the first fitting part and the second fitting part are designed as pivotable hinge parts.
